(19) United States
(12) Patent Application Publication
(10) Pub. No.: US 2021/0261394 A1
(43) Pub. Date: Aug. 26, 2021

(54) POSITION CONTROLLING SYSTEM

(71) Applicant: NATIONAL FORMOSA UNIVERSITY, Yunlin County (TW)

(72) Inventors: Jeng-Dao LEE, Yunlin County (TW); Cheng-Yi LI, Yunlin County (TW)

(21) Appl. No.: 16/927,547

(22) Filed: Jul. 13, 2020

(30) Foreign Application Priority Data
Feb. 25, 2020 (TW) 109106078

(51) Int. Cl. B66F 9/22

(52) U.S. Cl. CPC B66F 9/22

(57) ABSTRACT

A position controlling system is utilized to be externally connected to a manual hydraulic positioning machine. The position controlling system includes an operation interface, a position sensing assembly, and a control module. The operation interface is operated to define a target position. The position sensing assembly is utilized to sense a current position of a platform assembly of the manual hydraulic positioning machine. The controlling module is utilized to control a pressure-increasing unit and a pressure-releasing unit of the manual hydraulic positioning machine to reduce an overshoot of the platform assembly.

This application claims the benefit of Taiwan Patent Application Serial No. 109106078, filed Feb. 25, 2020, the subject matter of which is incorporated herein by reference.

### BACKGROUND OF THE INVENTION

### (1) Field of the Invention

The invention relates to a position controlling system.

### (2) Description of the Prior Art

Currently, hydraulic machines can be seen in various fields such as factories, warehouses, harbors, airports and goods distribution centers. The hydraulic machines for positioning can be generally classified into manual hydraulic positioning machines and automatic hydraulic positioning machines.

Refer now to FIG. 1 through FIG. 3; where FIG. 1 is a schematic view of a conventional manual hydraulic positioning machine, in which the platform assembly is lifted up toward a target position, FIG. 2 shows schematically another state of FIG. 1 that the platform assembly has reached the target position, and FIG. 3 shows schematically a further state of FIG. 1 that the platform assembly is overshot to a position higher than the target position. As shown, a manual hydraulic positioning machine PA1 includes a pressure-increasing unit PA11, a pressure-releasing unit PA12, a platform assembly PA13 and a drive mechanism PA14. In this embodiment, the manual hydraulic positioning machine PA1 can be, for example, a typical simple-structured manual hydraulic stacker.

The manual hydraulic positioning machine PA1 is activated by operating manually the pressure-increasing unit PA11 or the pressure-releasing unit PA12. In the case that the pressure-increasing unit PA11 is operated, the drive mechanism PA14 would be driven to apply a driving force in an ascent direction D1 to the platform assembly PA13. Then, the platform assembly PA13 would be lifted toward a target position LT in the ascent direction D1, as shown in FIG. 1. As soon as the platform assembly PA13 arrives the target position LT, the pressure-increasing unit PA11 would be stopped manually, as shown in FIG. 2. However, the platform assembly PA13 would keep a transient upward motion by an overshoot OS in the ascent direction D1, and then stop at an overshoot position LO. If the overshoot position LO is too high, then the pressure-releasing unit PA12 would be operated to reduce the driving force. As long as the driving force is lower than the corresponding gravity, the platform assembly PA13 would be moved in a descent direction D2 (labeled in FIG. 8).

After the platform assembly PA13 moves upward in the ascent direction D1 to reach the target position LT, it will keep going upward for a while to stop at the overshoot position LO, by the overshoot OS higher than the target position LT. Definitely, with the overshoot OS, accurate positioning is hard to achieve, and performance in uploading/downloading goods of this conventional design is poor. In a practical example, when the target position LT is 10 cm, a 5 cm overshoot OS would be generated for the platform assembly PA13 to carry a light load or nothing Namely, the platform assembly PA13 would stop at a 15 cm overshoot position LO.

Generally, the manual hydraulic positioning machine PA1 is equipped with an operation stick for controlling the pressure-increasing unit PA11 and the pressure-releasing unit PA12. Typically, the operation stick is pushed forward to increase the pressure, and pulled backward to release the pressure. In order to ensure the platform assembly PA13 to reach the target position LT, the operation stick is usually pushed forward till the platform assembly PA13 reaches the target position LT, and then pulled backward to release the pressure. Since the operation stick is purely human operated, hence an inevitable time difference exists between the end of pressure-increase stage and the onset of following pressure-release stage, and thus the overshoot OS is hard to reduce. If the pressure-increase stage is stopped too early (i.e., the pressure-release stage is started too early), a concern that the platform assembly PA13 may not reach the target position LT would be true. In addition, the judgment whether or not the target position LT has been reached depends highly upon naked eyes and personal experience, and is varying from time to time. Thereupon, operation coherence and convenience would be problems. Definitely, the conventional manual hydraulic positioning machine PA1 needs improvement. On the other hand, though the automated hydraulic positioning machine may be more convenient in manipulation, yet the associated cost is also high. In addition, the hydraulic proportional valve (one of key components) generally adopted by most of the automatic hydraulic positioning machines would be aged or fatigued to loose gradually its ability in increasing sufficient pressure.

### SUMMARY OF THE INVENTION

In view that the conventional manual hydraulic positioning machine is accompanied with various shortcomings in overshoot, continuity between stages of pressure increase and release, and naked-eye determination upon the target position, accordingly it is an object of the present invention to provide a position controlling system for resolving at least one of many problems in the art.

In the invention, the position controlling system, externally connected with a manual hydraulic positioning machine, is used for selectively transforming the manual hydraulic positioning machine into a quasi-automatic hydraulic positioning machine. The manual hydraulic positioning machine includes a pressure-increasing unit, a pressure-releasing unit, a drive mechanism and a platform assembly. The pressure-increasing unit is used for being controlled to have the drive mechanism to apply a driving force in an ascent direction upon the platform assembly. The platform assembly undergoes an overshoot to reach an overshoot position after moving in the ascent direction to reach a target position. The pressure-releasing unit is used for being controlled to reduce the driving force after the platform assembly reaches the overshoot position. The platform assembly moves downward from the overshoot position when the driving force is smaller than a gravity. The position controlling system includes an operation interface, a position sensing assembly and a control module.

The operation interface is used for inputting the target position in an auto control mode and then outputting a corresponding setting signal. The position sensing assembly, connected with the platform assembly, is used for sensing a current position of the platform assembly and then generating a corresponding sensing signal. The control module, communicatively connected with the operation interface and the position sensing assembly, is used for receiving the setting signal and the sensing signal, and further for evaluating the target position and the current position to transmit a corresponding platform control signal to the pressure-increasing unit and the pressure-releasing unit. When the current position is lower than the target position, the pressure-increasing unit applies the driving force to move the platform assembly in the ascent direction. When the platform assembly reaches the target position, the pressure-releasing unit reduces the driving force to reduce the overshoot caused by a continuous movement of the platform assembly in the ascent direction, so that the overshoot position of the platform assembly can be lowered.

In one embodiment of the present invention, the control module, includes a pressure-increasing control unit and a pressure-releasing control unit. The pressure-increasing control unit, electrically coupled with the pressure-increasing unit, is used for transmitting the platform control signal to a pressure-increasing electromagnetic valve of the pressure-increasing unit so as to move the platform assembly in the ascent direction. The pressure-releasing control unit, electrically coupled with the pressure-releasing unit, is used for transmitting the platform control signal to a pressure-releasing electromagnetic valve of the pressure-releasing unit so as to reduce the driving force upon when the platform assembly moves in the ascent direction toward a valve-alternating position.

In one embodiment of the present invention, the control module further includes a judgment unit electrically coupled with pressure-releasing control unit, and a stop signal is generated to stop reducing the driving force by the pressure-releasing control unit so as to stop the platform assembly at the target position when the judgment unit determines that the platform assembly moves in a descent direction and the current position is equal to the target position.

In one embodiment of the present invention, the control module further includes a valve-alternating setting unit, electrically coupled with the judgment unit and the operation interface, and used for setting the valve-alternating position.

In one embodiment of the present invention, the operation interface includes an input unit, and the input unit is at least one of a keyboard, a button, a knob, a touch device and a voice input device.

In one embodiment of the present invention, the operation interface includes a display unit for displaying the target position and the current position.

In one embodiment of the present invention, the display unit is one of a screen, a seven-segment display, an eight-segment display, an LCD and a light display.

In one embodiment of the present invention, the operation interface includes an operation-mode selection unit for switching the position controlling system between the auto control mode and a manual control mode.

In one embodiment of the present invention, the position sensing assembly is one of a draw-wire encoder, a draw-wire potentiometer and a draw-wire analog sensor.

In one embodiment of the present invention, the position sensing assembly is one of an optical sensor and a magnetic sensor.

In one embodiment of the present invention, the operation interface includes a memory unit for being controlled to memorize at least one said current position, and the defining the at least one said current position as at least one corresponding teaching position.

As stated, the position controlling system provided by the present invention applies the operation interface, the position sensing assembly and the control module to reduce the overshoot and to lower the overshoot position. In addition, the present invention can further apply the memory unit to define the teaching position, so that an advantage in automatic positioning can be obtained.

All these objects are achieved by the position controlling system described below.

### BRIEF DESCRIPTION OF THE DRAWINGS

The present invention will now be specified with reference to its preferred embodiment illustrated in the drawings, in which:

FIG. 1 is a schematic view of a conventional manual hydraulic positioning machine, in which the platform assembly is lifted up toward a target position;

FIG. 2 shows schematically another state of FIG. 1, in which the platform assembly has reached the target position;

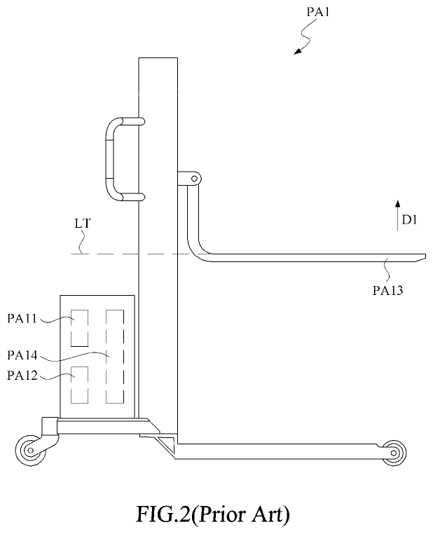

FIG. 3 shows schematically a further state of FIG. 1, in which the platform assembly is overshot to a position higher than the target position;

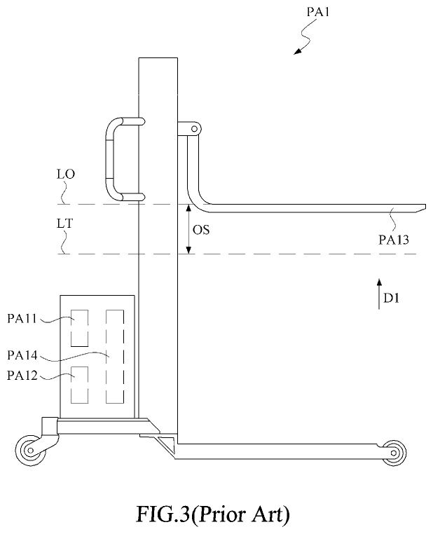

FIG. 4 is a block view of a preferred position controlling system in accordance with the present invention;

FIG. 5 shows schematically the conventional manual hydraulic positioning machine of FIG. 1 loaded externally with the position controlling system of FIG. 4;

FIG. 6 demonstrates schematically an embodiment of the operation interface of FIG. 4;

FIG. 7 shows schematically another state of FIG. 5, in which the platform assembly has been raised to a higher position by the position controlling system of this invention;

FIG. 8 shows schematically a further state of FIG. 5, demonstrating that possible overshoot has been reduced by the position controlling system of this invention; and

FIG. 9 shows schematically that the platform assembly of the position controlling system of this invention is rested at the target position.

### DESCRIPTION OF THE PREFERRED EMBODIMENT

The invention disclosed herein is directed to a position controlling system. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

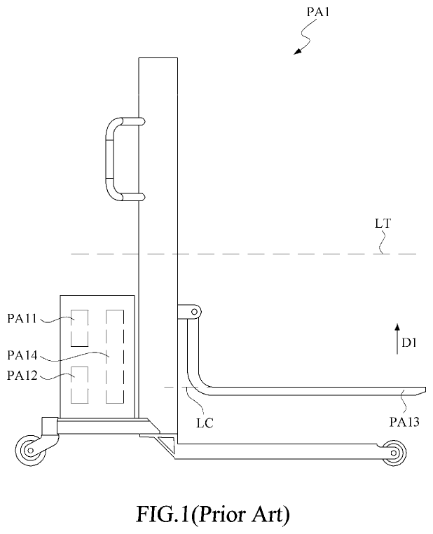

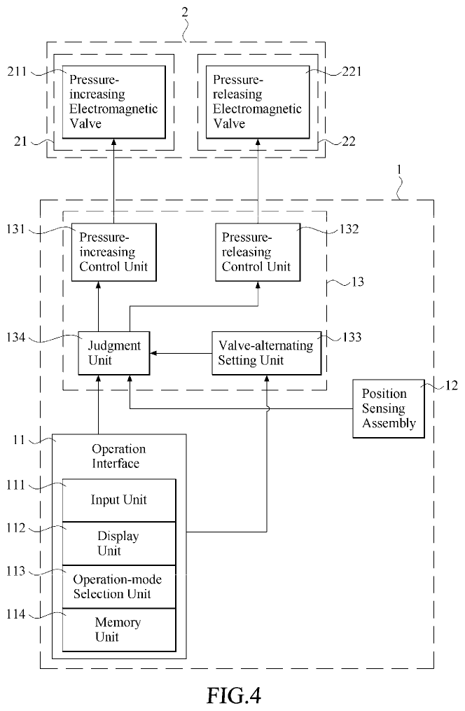

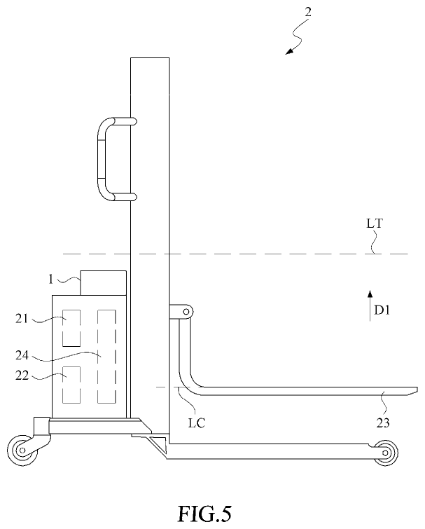

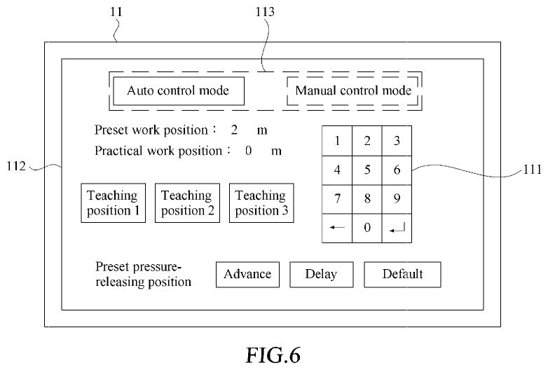

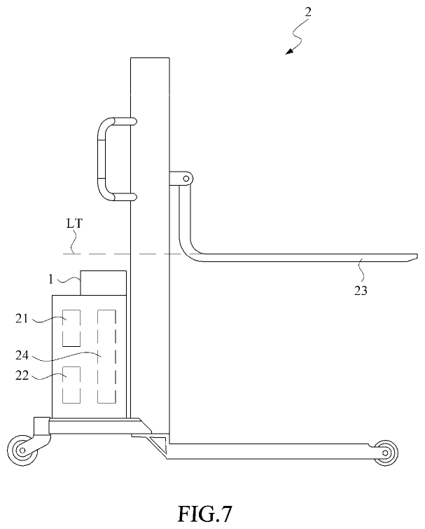

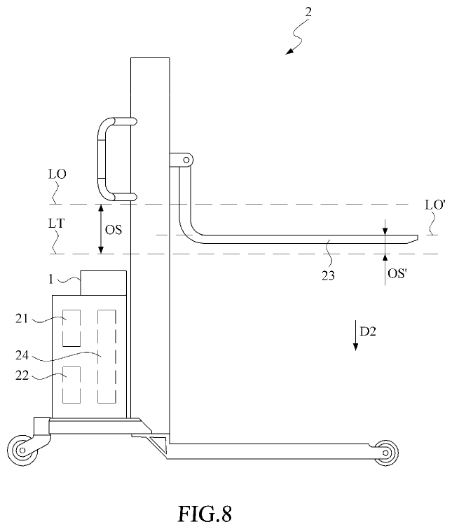

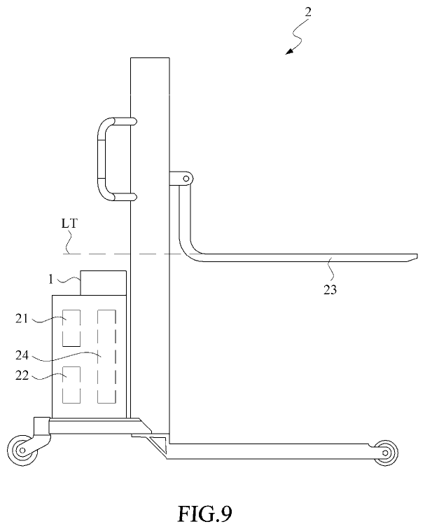

Refer now to FIG. 4 through FIG. 9; where FIG. 4 is a block view of a preferred position controlling system in accordance with the present invention, FIG. 5 shows schematically the conventional manual hydraulic positioning machine of FIG. 1 loaded externally with the position controlling system of FIG. 4, FIG. 6 demonstrates schematically an embodiment of the operation interface of FIG. 4, FIG. 7 shows schematically another state of FIG. 5 that the platform assembly has been raised to a higher position by the position controlling system of this invention, FIG. 8 shows schematically a further state of FIG. 5 demonstrating that possible overshoot has been reduced by the position controlling system of this invention, and FIG. 9 shows schematically that the platform assembly of the position controlling system of this invention is rested at the target position. As shown, the position controlling system 1, externally connected with a manual hydraulic positioning machine 2, includes an operation interface 11, a position sensing assembly 12 and a control module 13.

The manual hydraulic positioning machine 2, resembled to the aforesaid manual hydraulic positioning machine PA1 in the previous background section, includes a pressure-increasing unit 21, a pressure-releasing unit 22, a platform assembly 23 and a drive mechanism 24. When the pressure-increasing unit 21 is controlled to have the drive mechanism 24 to apply a driving force in an ascent direction D1 upon the platform assembly 23, the platform assembly 23 would be lifted up in the ascent direction D1. The pressure-releasing unit 22 is controlled for reducing the driving force. When the driving force is less than the gravity, the platform assembly 23 would be moved downward in a descent direction D2. Normally, when the platform assembly 23 moves in the ascent direction D1 to reach a target position LT, it might not stop immediately, but keep moving upward in the ascent direction D1 by an overshoot OS to reach an overshoot position LO. In this embodiment, the manual hydraulic positioning machine 2 can be, but not limited to, a stacker, an elevator, or any manual hydraulic machine the like.

The operation interface 11 is used for inputting a target position LT in an auto control mode, and thereby generating a corresponding setting signal. In this embodiment, the operation interface 11 includes an input unit 111, a display unit 112 and an operation-mode selection unit 113. The input unit 111 can be a keyboard, a button, a knob, a touch device or a voice input device. The display unit 112 can be a screen, a seven-segment display, an eight-segment display, an LCD (Liquid crystal display) or a light display, for displaying at least the target position LT and a current position LC of the platform assembly 23. The operation-mode selection unit 113 is controlled to determine an auto control mode or a manual control mode for the manual hydraulic positioning machine 2.

The position sensing assembly 12, coupled with the platform assembly 23, is used for detecting the current position LC of the platform assembly 23, and thereby for generating a sensing signal. In this embodiment, the position sensing assembly 12 can be, but not limited to, a draw-wire encoder. In some other embodiments, the position sensing assembly 12 can be a draw-wire potentiometer or a draw-wire analog sensor. In addition, the position sensing assembly 12 can be an optical position sensing assembly or a magnetic position sensing assembly; for example, a non-contact position sensing assembly such as an optical ruler or a magnetic ruler, any of which may be more expensive than the aforesaid position sensing assembly. In this embodiment, the position sensing assembly 12 can detect, but not limited to, the current position LC of the platform assembly 23, while the platform assembly 23 is ascending. In the art, platform assembly 23 may not be positioned while in a descending stage. However, in this present invention, the position sensing assembly 12 can be used for detecting the current position LC, even when the platform assembly 23 is descending.

The control module 13, communicatively coupled with the operation interface 11 and the position sensing assembly 12, is used for receiving setting signals and sensing signals. Then, the control module 13 would evaluate the target position LT and the current position LC to transmit a platform control signal to the pressure-increasing unit 21 and the pressure-releasing unit 22. In this embodiment, the control module 13 includes a pressure-increasing control unit 131, a pressure-releasing control unit 132, a valve-alternating setting unit 133 and a judgment unit 134.

Further, after the position controlling system 1 is externally connected with the manual hydraulic positioning machine 2, the operation-mode selection unit 113 can be applied to switch the position controlling system 1 into the auto control mode. In FIG. 6, the operation-mode selection unit 113 has two options; an “Auto control mode” and a “Manual control mode”. However, in some other embodiments, the operation-mode selection unit 113 may have more than two options. After the position controlling system 1 is switched into the auto control mode via the operation-mode selection unit 113, the input unit 111 can be used to input the target position LT, and then to output a corresponding setting signal. At this time, the position sensing assembly 12 would sense the current position LC of the platform assembly 23, and generate a corresponding sensing signal.

The judgment unit 134 of the control module 13 would determine the current position LC and the target position LT, and then a corresponding platform control signal would be transmitted to the pressure-increasing control unit 131 or the pressure-releasing control unit 132. With the platform control signal to be transmitted to the pressure-increasing unit 21 or the pressure-releasing unit 22, a pressure-increasing electromagnetic valve 211 of the pressure-increasing unit 21 or a pressure-releasing electromagnetic valve 221 of the pressure-releasing unit 22 can be controlled to be opened or closed.

The judgment unit 134 is generally used for determining whether or not the current position LC has reached the target position LT. If the judgment is negative, then the pressure-increasing control unit 131 would keep the pressure-increasing electromagnetic valve 211 opened, so that the pressure-increasing unit 21 can keep controlling the drive mechanism 24 to provide a driving force to the platform assembly 23, and thus the platform assembly 23 can keep moving toward the target position LT in the ascent direction D1. At this time, the pressure-releasing control unit 132 would have the pressure-releasing electromagnetic valve 221 closed.

When the judgment unit 134 determines that the current position LC has reached a valve-alternating position preset by the valve-alternating setting unit 133, the pressure-increasing control unit 131 would close the pressure-increasing electromagnetic valve 211, and simultaneously the pressure-releasing control unit 132 would open the pressure-releasing electromagnetic valve 221 for lowering the driving force. In general, the valve-alternating position is preset to be the same as or in front of the target position LT. In the case that the valve-alternating position is set to be the same as the target position LT, then, when the platform assembly 23 reaches valve-alternating position (i.e., the target position LT), the pressure-increasing control unit 131 would close the pressure-increasing electromagnetic valve 211, and simultaneously the pressure-releasing control unit 132 would open the pressure-releasing electromagnetic valve to lower the driving force.

In the prior art as described above, after the pressure-increasing unit PA11 is stopped, the platform assembly PA13 would keep moving upward in the ascent direction D1 by the overshoot OS. On the other hand, in this present invention, the pressure-releasing electromagnetic valve 221 is opened simultaneously, and thus the overshoot OS can be substantially reduced. In FIG. 8, the overshoot of this invention is labeled by OS′, while the OS stands for the overshoot contributed in the art. It is obvious that the present overshoot OS′ would be less than the aforesaid overshoot OS, such that the platform assembly 23 of this present invention would stop at an overshoot position LO′, lower than the aforesaid overshoot position LO. In addition, in comparison with the prior art that a time difference would be generated by manual control, the present invention, that utilizes electric signals to control the pressure-increasing electromagnetic valve 211 and the pressure-releasing electromagnetic valve 221, can be benefited from the synchronous control. Experimentally, the overshoot OS' of this present invention is lowered within 1 cm.

If the platform assembly 23 still stops beyond the target position LT by an unacceptable overshoot OS′, the valve-alternating setting unit 133 can be used to adjust the valve-alternating position slightly prior to the target position LT, then closing of the pressure-increasing electromagnetic valve 211 and opening of the pressure-releasing electromagnetic valve would occur prior to reaching the target position, such that, hopefully, the overshoot OS' can be adjusted obtained to meet the difference between the valve-alternating position and the target position. It is noted that the valve-alternating setting unit 133, electrically coupled with the judgment unit 134, controls the pressure-releasing control unit 132 to open the pressure-releasing electromagnetic valve 221 through the judgment unit 134. On the other hand, the valve-alternating setting unit 133, directly coupled electrically with the pressure-releasing control unit 132, can open the pressure-releasing electromagnetic valve 221 via the pressure-releasing control unit 132. In addition, the judgment unit 134, the pressure-increasing control unit 131 and the pressure-releasing control unit 132 can be integrated in a modularization manner into a chip with both judgment and control functions.

As the pressure-releasing control unit 132 keeps opening the pressure-releasing electromagnetic valve 221, the driving force would finally reduce to be lower than the gravity, and then the platform assembly 23 would be driven by the gravity to move toward the target position LT in the descent direction D2 from the overshoot position LO′. At this time, the position sensing assembly 12 would keep sensing the current position LC of the platform assembly 23. When the judgment unit 134 determines that the current position LC has been lowered to the target position LT, a corresponding stop signal would be generated. As the pressure-releasing control unit 132 receives the stop signal, the pressure-releasing electromagnetic valve 221 would be closed to prevent the platform assembly 23 from being moved in the descent direction D2 to a position lower than the target position LT. Thereupon, the platform assembly 23 can accurately stop at the inputted target position LT, such that the aforesaid shortcomings caused by naked-eye observation and human judgment can be substantially resolved.

In this embodiment, the operation interface 11 further includes a memory unit 114 for storing the current position LC of the platform assembly 23 as a teaching position. In other words, when the current position LC of the platform assembly 23 is a popular target position LT now or recently, the memory unit 114 can be sued to memorize the current position LC. Hence, if necessary, a specific teaching position in the memory unit 114 can be directly used for controlling the movement of the platform assembly 23, without additional step to input the target position LT. Namely, convenience of corresponding operations can be further enhanced. The memory unit 114 can store a plurality of current positions LC into correspondingly a plurality of teaching positions. Practically, the teaching positions memorized or defined by the memory unit 114 can be displayed on the display unit 112. As shown in FIG. 6, “Teaching position 1”, “Teaching position 2” and “Teaching position 3” are listed for selectively clicking a desired teaching position for moving the the platform assembly 23.

In this embodiment, “Teaching position 1” can be long depressed to have the memory unit 114 to define the instant current position LC as an updated teaching position for the corresponding “Teaching position 1”. After the memory unit 114 finishes the foregoing recording, then “Teaching position 1” can be depressed anytime thereafter for controlling the platform assembly 23 to be moved to the teaching position respective to “Teaching position 1”, no matter if the instant current position LC of the platform assembly 23 is higher or lower than the teaching position.

After the position controlling system of this invention is externally connected to the manual hydraulic positioning machine, the manual hydraulic positioning machine can be selectively transformed into a quasi-automatic hydraulic positioning machine. The quasi-automatic hydraulic positioning machine herein implies that the manual hydraulic positioning machine can provide similar functions that the automatic hydraulic positioning machine can provide, and also maintain original functions of the manual hydraulic positioning machine.

In summary, the position controlling system provided by this invention can equip the manual hydraulic positioning machine with functions similar to the automatic hydraulic positioning machine can have. In comparison with the prior art, the position controlling system of this invention can effectively reduce the overshoot and lower the overshoot position, by synchronously substantially stopping the pressure-increasing unit and activating the pressure-releasing unit. In addition, by providing the operation interface, the naked-eye observation and human judgment can be avoided in the operation of this invention, and thus operation convenience can be significantly improved. In comparison to the conventional automatic hydraulic positioning machine equipped with an automatic positioning system, the position controlling system provided by this invention is much cheaper, and the fatigue or aging concern at the hydraulic proportional valve can be waived. In addition, by providing the memory unit to remember the teaching positions, the operation convenience and the control accuracy in positioning the platform assembly can be substantially enhanced.

While the present invention has been particularly shown and described with reference to a preferred embodiment, it will be understood by those skilled in the art that various changes in form and detail may be without departing from the spirit and scope of the present invention.

What is claimed is:

1. A position controlling system, externally connected with a manual hydraulic positioning machine, used for selectively transforming the manual hydraulic positioning machine into a quasi-automatic hydraulic positioning machine, the manual hydraulic positioning machine including a pressure-increasing unit, a pressure-releasing unit, a drive mechanism and a platform assembly, the pressure-increasing unit being used for being controlled to have the drive mechanism to apply a driving force in an ascent direction upon the platform assembly, the platform assembly undergoing an overshoot to reach an overshoot position after moving in the ascent direction to reach a target position, the pressure-releasing unit being used for being controlled to reduce the driving force after the platform assembly reaches the overshoot position, the platform assembly moving downward from the overshoot position when the driving force is smaller than a gravity, the position controlling system comprising:
an operation interface, used for inputting the target position in an auto control mode and then outputting a corresponding setting signal;
a position sensing assembly, connected with the platform assembly, used for sensing a current position of the platform assembly and then generating a corresponding sensing signal; and
a control module, communicatively connected with the operation interface and the position sensing assembly, used for receiving the setting signal and the sensing signal, and further for evaluating the target position and the current position to transmit a corresponding platform control signal to the pressure-increasing unit and the pressure-releasing unit; wherein, when the current position is lower than the target position, the pressure-increasing unit applies the driving force to move the platform assembly in the ascent direction; wherein, when the platform assembly reaches the target position, the pressure-releasing unit reduces the driving force to reduce the overshoot caused by a continuous movement of the platform assembly in the ascent direction, so that the overshoot position of the platform assembly is lowered.

2. The position controlling system of claim 1, wherein the control module includes:
a pressure-increasing control unit, electrically coupled with the pressure-increasing unit, used for transmitting the platform control signal to a pressure-increasing electromagnetic valve of the pressure-increasing unit to move the platform assembly in the ascent direction; and
a pressure-releasing control unit, electrically coupled with the pressure-releasing unit, used for transmitting the platform control signal to a pressure-releasing electromagnetic valve of the pressure-releasing unit to reduce the driving force upon when the platform assembly moves in the ascent direction toward a valve-alternating position.

3. The position controlling system of claim 2, wherein the control module further includes a judgment unit electrically coupled with the pressure-releasing control unit, and a stop signal is generated to stop reducing the driving force by the pressure-releasing control unit so as to stop the platform assembly at the target position when the judgment unit determines that the platform assembly moves in a descent direction and the current position is equal to the target position.

4. The position controlling system of claim 3, wherein the control module further includes a valve-alternating setting unit, electrically coupled with the judgment unit and the operation interface, and used for setting the valve-alternating position.

5. The position controlling system of claim 1, wherein the operation interface includes an input unit, and the input unit is at least one of a keyboard, a button, a knob, a touch device and a voice input device.

6. The position controlling system of claim 1, wherein the operation interface includes a display unit for displaying the target position and the current position.

7. The position controlling system of claim 6, wherein the display unit is one of a screen, a seven-segment display, an eight-segment display, an LCD and a light display.

8. The position controlling system of claim 1, wherein the operation interface includes an operation-mode selection unit for switching the position controlling system between the auto control mode and a manual control mode.

9. The position controlling system of claim 1, wherein the position sensing assembly is one of a draw-wire encoder, a draw-wire potentiometer and a draw-wire analog sensor.

10. The position controlling system of claim 1, wherein the position sensing assembly is one of an optical sensor and a magnetic sensor.

11. The position controlling system of claim 1, wherein the operation interface includes a memory unit for being controlled to memorize at least one said current position, and the defining the at least one said current position as at least one corresponding teaching position.
